(19) United States
(12) Patent Application Publication
(10) Pub. No.: US 2008/0183554 A1
(43) Pub. Date: Jul. 31, 2008

(54) System and method for providing customized catalogs

(75) Inventors: Geoffry A. Westphal, Park Ridge, IL (US); Thomas J. Carroll, Algonquin, IL (US)

Correspondence Address: GREENBERG TRAURIG, LLP, 77 WEST WACKER DRIVE, SUITE 2500, CHICAGO, IL, 60601-1732, US

(73) Assignee: W.W. Grainger, Inc., Lake Forest, IL (US)

(21) Appl. No.: 11/699,147

(22) Filed: Jan. 29, 2007

(51) Int. Cl. G06Q 99/00

(52) U.S. Cl. 705/10

(57) ABSTRACT

Buying patterns and/or characteristics of a target customer are used to discern a reference customer that is characteristically related to the reference customer. Once a reference customer for the target customer is discerned, the system and method uses information regarding the reference customer, alone or further considering information regarding the target customer, to select items and/or item pages from a large, general product catalog and/or items and/or item pages listing products/services of one or more vendors, which selected items and/or item pages may then be aggregated into a customized catalog that is to be made accessible to and/or distributed to the target customer.

### BACKGROUND

The following relates generally to systems and methods for providing customized catalogs and also relates to a system and method which provides customized catalogs through the use of cluster analysis.

In the art of catalog distribution it is recognized that the cost of printing a large, general product catalog, such as the Grainger brand catalog which currently exceeds 4000 pages, is expensive. It is also recognized that shipping and handling fees associated with distributing such catalogs further increase these costs. Accordingly, distributors of large, general product catalogs are often forced to make decisions with respect to whether or not particular customers should receive such catalogs. For example, recognizing that it is cost prohibitive to distribute copies of large, general product catalogs to customers indiscriminately, distributors may elect to not distribute such catalogs to customers that may have a low probability of making a purchase or to customers that make only small dollar amount and infrequent purchases.

It is also recognized in the art of catalog distribution that, even when a catalog is provided to an organizational customer, the catalog may still not be readily accessible to all persons that would actually be interested in the catalog. For example, in cases where a limited number of catalogs are provided to customers such as large and medium-sized organizations, it has been seen that the distributed catalogs are often inconveniently kept with a manager or purchasing director and thus away from those persons that would be in a relatively better position to recognize and/or specify which products should be purchased. Yet further, it is also known that even larger organizational customers only purchase from a small subset of a large, i.e., multi-thousand-page, general product catalog.

From the foregoing, it will be appreciated that a need exists for alternative, more cost effective approaches to publishing and distributing catalogs.

### SUMMARY

To address this and other needs, described hereinafter is a system and method for providing customized catalogs. Also described hereinafter is a system and method which utilizes cluster analysis to provide such customized catalogs. By way of example only, the system and method may use buying patterns and/or characteristics of a target customer to relate the target customer to a reference customer where the reference customer, as compared to the target customer, has a relatively more developed purchasing history with the catalog distributor and/or product/service vendor(s) available to be included within a customized catalog. Once a reference customer for the target customer is discerned, the system and method may then function to use information regarding the reference customer, alone or further considering information regarding the target customer, to select items and/or pages from a large, general product catalog and/or items and/or pages listing products/services of one or more vendors, which selected items and/or pages may then be aggregated into a customized catalog that is to be made accessible to and/or distributed to the target customer. In this manner, it will be understood that a customized catalog may be provided to a target customer that, from the point of view of a catalog distributor, is relatively more cost-effective since the customized catalog will, among other things, be less bulky as it should include those items and/or item pages that the target customer will be most likely to purchase from to the exclusion of those items and/or item pages that the target customer is less likely to purchase from. Moreover, since a customized catalog will be smaller in volume than conventional, large, general product catalogs, it will be understood that a customized catalog may have the advantage of having a size that is conducive to allowing the downloading of the customized catalog by a target customer via a computer network such as the Internet while further having the advantage, from the point of view of the catalog distributor, of eliminating the cost of shipping and of shifting at least the costs associated with printing the catalog to the target customer. Yet further, it will be understood that providing a relatively smaller and more focused catalog that may be printed at will by a target customer should function to place the customized catalog in more places within a facility of a target customer and/or into the hands of more target customer employed personnel. While this illustrates some of the advantages of the subject system and method, a better understanding of the objects, advantages, features, properties and relationships of the subject system and method will be obtained from the following detailed description and accompanying drawings which set forth illustrative embodiments which are indicative of the various ways in which the principles of the subject system and method may be employed.

### BRIEF DESCRIPTION OF THE DRAWINGS

For a better understanding of the systems and methods described hereinafter reference may be had to preferred embodiments shown in the following drawings in which:

FIG. 1 is a block diagram illustrating an exemplary computer system in which the principles of the described invention may be employed;

FIG. 2 is a flow chart diagram illustrating exemplary steps utilized in connection with the creation of a customized catalog; and

FIG. 3 illustrates an exemplary customized catalog page.

### DETAILED DESCRIPTION

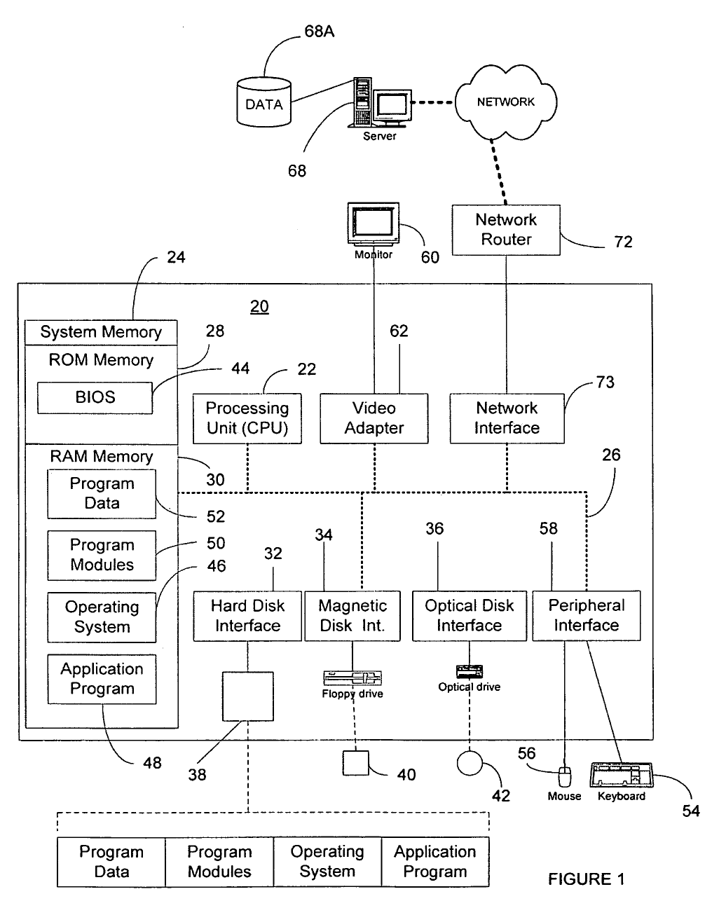

Turning to the drawings, wherein like reference numerals refer to like elements, an exemplary system and method for providing customized catalogs is now described. By way of example only and as illustrated in FIG. 1, the system and method will be described in the context of a plurality of processing devices linked via a network, such as the World Wide Web or the Internet. In this regard, a first processing device 20, illustrated in the exemplary form of a personal computer system, is provided with executable instructions to, for example, provide a means for a user (whether the target customer, sales representative for the distributor, or the like) to access a second processing device 68, illustrated in the exemplary form of a Web server, similarly having computer executable instructions, to provide to the second processing device 68 information relative to a target customer, such as characteristic or interests information of the target customer, past or planned purchasing activities of the target customer, and/or other similar type of information associated with the target customer, to thereby allow the second processing device 68 to relate the target customer to a reference customer and to further allow the remote processing device to use the information and relationship to provide a catalog customized for the target customer. In certain circumstances, the first processing device 20 may also be utilized to request access to (e.g., display of) and/or downloading of a customized catalog by the second processing device 68.

It will be understood by those of skill in the art that the computer executable instructions of the processing devices may reside in program modules which may include routines, programs, objects, components, data structures, etc. Accordingly, those skilled in the art will further appreciate that the processing devices may be embodied in any type of device having the ability to execute instructions such as, by way of example only, a personal computer, a mainframe computer, a personal-digital assistant (“PDA”), a cellular telephone, or the like. Furthermore, while described and illustrated in the context of a pair of processing devices, e.g., a client and a server communicating via the Internet, those skilled in the art will still further appreciate that the various tasks described hereinafter may be practiced on a single computing device, in a distributed environment having multiple processing devices linked via a local or wide-area network whereby the executable instructions may be associated with and/or executed by one or more of multiple processing devices, or otherwise without limitation.

For performing the various tasks in accordance with the executable instructions, the processing devices, with exemplary reference to first processing device 20, will include a processing unit 22 and a system memory 24 which may be linked via a bus 26. Without limitation, the bus 26 may be a memory bus, a peripheral bus, and/or a local bus using any of a variety of well-know or future developed bus architectures. As needed for any particular purpose, the system memory 24 may include read only memory (ROM) 28 and/or random access memory (RAM) 30. Additional memory devices may also be made accessible to the processing devices by means of, for example, a hard disk drive interface 32, a magnetic disk drive interface 34, and/or an optical disk drive interface 36. As will be understood, these memory devices, which would be linked to the system bus 26, respectively allow for reading from and writing to a hard disk 38, reading from or writing to a removable magnetic disk 40, and for reading from or writing to a removable optical disk 42, such as a CD/DVD ROM or other optical media. The drive interfaces and their associated computer-readable media allow for the nonvolatile storage of computer readable instructions, data structures, program modules and other data as required by the processing devices. Those skilled in the art will further appreciate that other types of computer readable media that can store data may be used for this same purpose. Examples of such media devices include, but are not limited to, magnetic cassettes, flash memory cards, digital videodisks, Bernoulli cartridges, random access memories, nano-drives, memory sticks, and other read/write and/or read-only memories.

A number of program modules may be stored in one or more of the memory/media devices. For example, a basic input/output system (BIOS) 44, containing the basic routines that help to transfer information between elements within the processing device 20, such as during start-up, may be stored in ROM 28. Similarly, the RAM 30, hard drive 38, and/or peripheral memory devices may be used to store computer executable instructions comprising an operating system 46, one or more applications programs 48 (such as a Web browser), other program modules 50, and/or program data 52. Still further, computer-executable instructions may be downloaded to one or more of the computing devices as needed, for example, via a network connection.

To allow a user to enter commands and/or information to be utilized by the processing devices, the processing devices may have associated input devices such as a keyboard 54 and/or a pointing device 56. While not illustrated, other input devices may include a microphone, a joystick, a game pad, a scanner, etc. These and other input devices would typically be connected to the processing unit 22 by means of an interface 58 which, in turn, would be coupled to the bus 26. Input devices may be connected to the processor 22 using interfaces such as, for example, a parallel port, game port, firewire, or a universal serial bus (USB). To view information, the processing devices may have an associated monitor 60 or other type of display device that would be connected to the bus 26 via an interface, such as a video adapter 62. In addition to the monitor 60, the processing devices may also include other peripheral output devices, not shown, such as speakers and printers.

As noted above, the first processing device 20 may also utilize logical connections to the second processing device 68 which, in this example, has an associated data repository 68A in which may be stored information collected with respect to target and/or reference customers, item catalog pages in electronic form, etc. Communications between the first processing device 20 and the second processing device 68 may be exchanged via a further processing device, such as a network router 72, that is responsible for network routing. Communications with the network router 72 may be performed via a network interface component 73. Thus, within such a networked environment, e.g., the Internet, World Wide Web, LAN, or other like type of wired or wireless network, it will be appreciated that program modules depicted relative to the first processing device 20, or portions thereof, may be stored in the memory storage device(s) of the second processing device 68.

To provide a personalized or customized catalog to a target customer, whether an individual, organization, etc., information regarding the target customer is generally used to select a reference customer, whether an individual, organization, category of customer, etc., to which the target customer favorably compares whereupon information regarding that reference customer (alone or further using information regarding the target customer) is used to provide the customized catalog. By way of example and without limitation, a reference customer may be a single selected customer or a group of selected customers. Furthermore, certain identifiable categories of customers, such as HVAC specialists, plumbers, safety managers, military, etc. (e.g., vocations), may each be provided with one or more reference customers. The category in which a reference customer is to be placed may be defined by the reference customer (for example via the answering of questions by the reference customer), by categorizing reference customers based upon their prior purchasing history, etc. Once potential reference customers are thus categorized, the one or more customers that are to be selected for actual use as reference customer(s) for a particular category of customers may be those that have characteristic(s) that meet one or more defined thresholds such as, by way of further example, total dollars spent, dollars spent over a given period of time, total number of items ordered, number of items ordered over a given period or time, total items purchased within a determined item category, items purchased within a determined item category over time, total number of unique items purchased, etc. Once a single customer or group of customers has been selected from the pool of possible reference customers, i.e., to be used as actual reference customer(s), it will be appreciated that information such as the prior purchasing activities of the selected one or more customers with the catalog distributor and/or vendor(s) available for inclusion within a customized catalog may then be available for use in creating a customized catalog as further described below. As will be further appreciated, the process of selecting the one or more customers that are to serve as a reference customer may be automated or performed manually using the previously described, exemplary computer system in whole or in part without limitation.

For purposes of recognizing a target customer, i.e., a customer that it may be desirable to provide with a customized catalog, it may be determined if a customer falls within a customer category that is defined to achieve this goal. By way of example, it may be determined that a customer is a target customer if the customer: 1) has not purchased before from the catalog distributor and/or vendor(s) available for inclusion within a customized catalog; 2) has not purchased from the catalog distributor and/or vendor(s) available for inclusion within a customized catalog for a selected period of time; 3) purchases less than a threshold amount of total items, selected items, etc. within a selected period of time from the catalog distributor and/or vendor(s) available for inclusion within a customized catalog with or without regard to whether the customer currently receives a copy of a large, general catalog; 4) does not purchase enough to cover the cost of providing a large, general catalog to the customer; or 5) purchases frequently from a vendor but does not receive an adequate number of large, general catalogs in relation to the potential number of end users at the customers' location(s). As before, it will be appreciated that the process of identifying a customer as a target customer may be automated or performed manually using the previously described, exemplary computer system in whole in or part without limitation.

To further assist in selecting reference customer(s) for a target customer (whether from a global pool of reference customers or from types/categories of reference customers), it may be further desired to create a series of questions that may be asked to customers. In this regard, the questions may be job related and/or may be of a more personal nature depending upon a desired result. Furthermore, the questions may be posed to elicit information from mature customers, i.e., those customers that may be reference customers, as well as to elicit information from immature customers, i.e., those customer that may be target customers. It will be understood that, by asking questions to mature or reference customers, a baseline may be created that may then provide “business beacons” that can be used to help illuminate possible growth paths for an immature or target customer. By way of example, if a target customer and a reference customer share similar answers to a subset of questions, it can be concluded with some degree of certainty that the target customer is likely to purchase similar products as the reference customer. In order to establish accurate “business beacons” the mature or reference customers may be offered an incentive to answer all the questions completely, honestly, and thoroughly. By way of further example in the context of a distributor of industrial supplies, sample questions useful to discern relationships between a target customer and a reference customer are presented below in Table 1.

TABLE 1
What is your job title?
How many people are in your company/location?
What industry are you or your business in?
What ZIP code is your business located in?
What brand names are you partial to?
What other companies/distributors do you buy from?
What types of tools do you use?
What category(ies) of tools do you use?

It will be appreciated that the answers to such questions may be provided via interaction with a computer, such as by filling in answers via interaction with a Web page provided by a Web server, or may be manually obtained.

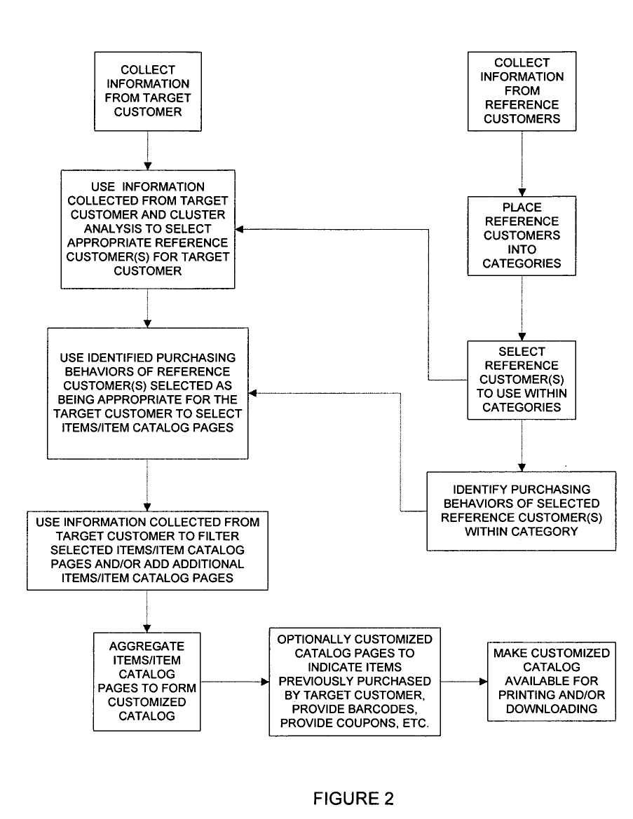

More particularly and as illustrated in FIG. 2, to select which reference customer(s) are most likely to correspond to the target customer, i.e., most likely to provide insight as to what the target customer is likely to purchase, a cluster analysis is preferably performed on the information collected, including answers provided to questions posed and other information that might otherwise be available to the system such as prior purchasing histories. As will be readily appreciated by those of skill in the art, cluster analysis encompasses any of a number of different algorithms and methods used to group objects of similar kind into a respective categories, i.e., cluster analysis is an exploratory data analysis tool which aims at sorting different objects into groups in a way that the degree of association between two objects is maximal if they belong to the same group and minimal otherwise.

Once one or more reference customers are identified for a target customer though the use of cluster analysis tools, the buying patterns for the reference customer(s) may be used to form a surrogate catalog template. For example, certain catalog pages that include items which the reference customer(s) have bought in the past may be aggregated to form a customized catalog for the target customer. The catalog pages selected for inclusion with the customized catalog, which may be extracted from previously created electronic catalogs or from previously created print pages, may be those that include items that the identified reference customer(s) have purchased in an amount and/or frequency that exceeds a predefined threshold. In certain further circumstances catalog pages that might otherwise be included within the customized catalog may be excluded based upon information collected from the target customer, e.g., an explicit indication that certain items are not of interest to the target customer. For example, the system may inquire as to whether the target customer is interested in buying common/commodity products from the vendor, or just uncommon/hard-to-find products from the vendor and, if the customer chooses common/commodity products, then the catalog pages may be biased towards the common/commodity bought products and, if the customer chooses uncommon products, then the personal product catalog pages may be biased towards the most frequently bought uncommon products only. Similarly, catalog pages that might not be otherwise included within the customized catalog based upon the purchasing behaviors of the reference customer(s) may be added to the customized catalog, e.g., those including items that the target customer has been know to buy in the past, those including items that the target customer has expressed an interest in, etc. The aggregated pages that form the customized catalog can then be bound or printed by the catalog distributor and sent to the target customer; printed by a sales rep of a vendor and then delivered to the target customer in person; sent to the target customer via an email attachment to then be printed by the target customer; or accessed or downloaded by the target customer via an internet link, the internet link possibly being sent by email; etc. to achieve the various goals set forth above.

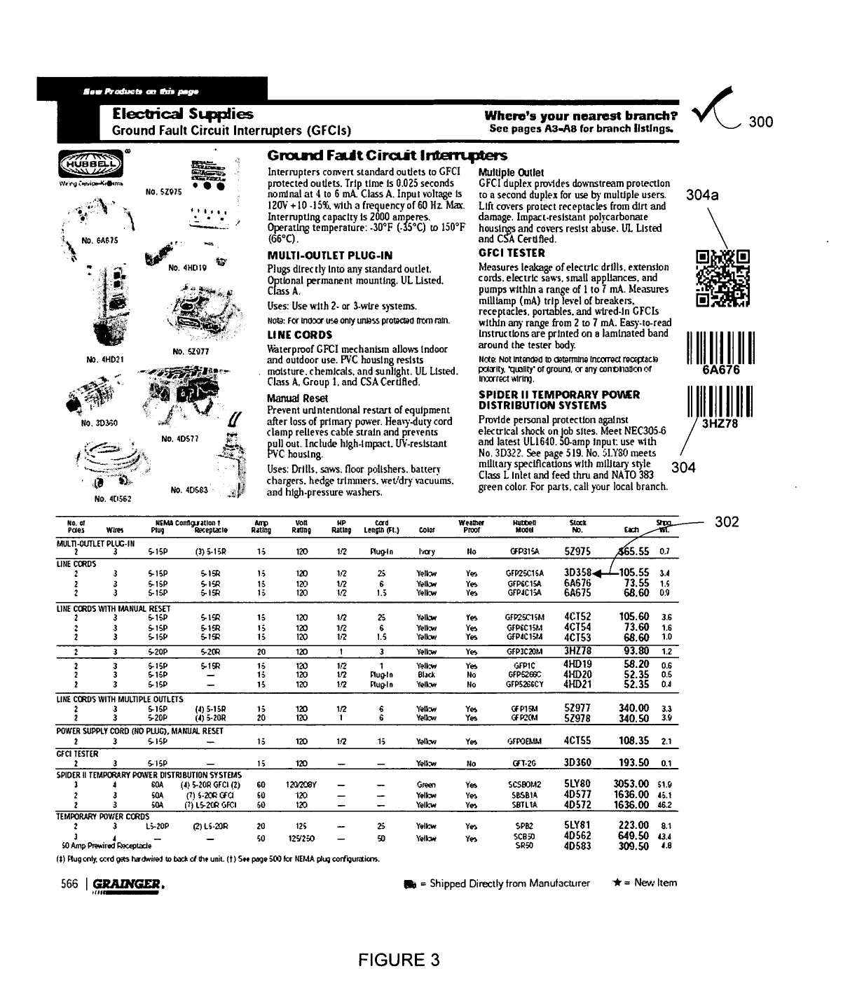

In further circumstances where a target customer has had some previous purchasing history recorded by the system, an easily recognizable, clearly visible mark (such as a check mark 300) may be placed upon applicable pages of that customer's personal product catalog to inform the target customer that they have previously purchased an item located on that page as is illustrated in FIG. 3. Highlighting of an item listing on a catalog page may also be used for this same purpose. For example, an arrow 302 may be included on a catalog page to point to an item within the catalog page that was previously purchased by the target customer. Still further, barcodes 304 for items that have been previously purchased by that customer may be provided upon the catalog pages (or in a separate page to be included within the catalog) to allow for convenient reordering of items using conventional barcode ordering methodologies. In this regard, the barcodes may be 2D barcodes 304a used to represent, for example, all items presented upon a catalog page, catalog information, etc. without limitation. Yet further, the customized catalog may be provided with coupon(s) provided for the purpose of driving sales of desired items. It will also be appreciated that the coupons might be provided with the catalog only in certain circumstances, e.g., by being omitted from or included with catalogs provided to target customer that have previous purchasing histories that meet certain predefined thresholds, by being provided only to customers that download and print the customized catalog, etc.

From the foregoing it will be seen that the described system and method allows for the assembling of a catalog where no prior catalog in that form previously existed. For example, an online music retailer can assemble not just a few product recommendations as a target customer buys music titles, but rather a comprehensive, personal music catalog for that customer's consideration. By using a target customer's previous music purchase history, their answer to personal questions, and cluster analysis, a projection can be made as to which reference customer group this given target customer has the potential of growing into. Thus, the described system can build, in this example, an mp3 music collection catalog for a target customer that provides a relatively larger selection of music that is also highly likely to be relevant to the user and which can then be provided to the target customer for consideration online or offline (via printing). As will be readily appreciated, the vendor benefits since the more meaningful and targeted selection of music titles will likely correlate to higher sales.

Similarly, the described system and method allows for the assembling of a new catalog from previously available catalogs of multiple vendors. For example, assume a target customer has answered personal questions about what model and make of car they own; about whether they are male or female; about their marital status; about brand names of clothing they have bought; about categories or brands of items they have or have not ever bought in their life etc. From these questions, it is possible with cluster analysis and information concerning prior purchasing histories of reference customers to determine from a collection of vendor catalogs which few pages from any of these catalogs to consider for inclusion into the new aggregate catalog. In this manner, a single male, age 28, who drives a BMW, who indicates he is a consultant, who occasionally wears cologne, and who owns a bread maker might, upon use of cluster analysis and consideration of prior purchasing histories of selected reference customers, receive a few pages from the Men's Collection from Saks, a few pages from William Sonoma catalog, a few pages from the Burberry Luggage catalog, and a few pages from the Sharper Image catalog.

While specific embodiments of the invention have been described in detail, it will be appreciated by those skilled in the art that various modifications and alternatives to those details could be developed in light of the overall teachings of the disclosure. For example, it will be understood that the various steps described herein need not be performed in the exact order set forth within this document and/or that the various processes described herein may be implemented using software, hardware, or both. Accordingly, the particular arrangements disclosed are meant to be illustrative only and not limiting as to the scope of the invention which is to be given the full breadth of the appended claims and any equivalents thereof.

All patents, patent applications, and other references cited within this document are hereby incorporated by reference in their entirety.

1. A method for creating a customized catalog, comprising:
collecting information from a target customer;
using the information collected from the target customer and a cluster analysis algorithm to select from a plurality of customers a reference customer for the target customer;
using previously captured purchasing behaviors specific to the reference customer to select items from a universe of items; and
aggregating the selected items to thereby create the customized catalog for the target customer.

2. The method as recited in claim 1, wherein each of the selected items is included on a pre-existing catalog page and the pre-existing catalog pages having the selected items are aggregated to thereby create the customized catalog.

3. The method as recited in claim 1, comprising using the information collected from the target customer to eliminate items from the selected items prior to the selected items being aggregated to thereby create the customized catalog.

4. The method as recited in claim 1, comprising using the information collected from the target customer to add items to the selected items prior to the selected items being aggregated to thereby create the customized catalog.

5. The method as recited in claim 2, comprising marking pre-existing catalog pages that include a selected item which the target customer is known to have previously purchased.

6. The method as recited in claim 2, comprising providing the customized catalog with a barcode indicative of a selected item which the target customer is known to have previously purchased.

7. The method as recited in claim 1, comprising including with the customized catalog a coupon for a selected item.

8. The method as recited in claim 1, comprising making the customized catalog available for downloading via the Internet.

9. The method as recited in claim 8, comprising providing to the target customer an email which includes a link to a downloadable version of the customized catalog.

10. The method as recited in claim 1, wherein the reference customer is selected from a plurality of reference customers within a predefined category of reference customers.

11. The method as recited in claim 10, wherein the predefined category is indicative of a vocation.

12. The method as recited in claim 10, comprising collecting information from the reference customer for determining a predefined category of reference customers into which the reference customer is to be placed whereby the predetermined category of reference customers is used to define the plurality of customers from which the target customer is selected.

13. The method as recited in claim 1, comprising using predetermined thresholds to eliminate items from the selected items prior to the selected items being aggregated to thereby create the customized catalog.

14. The method as recited in claim 13, wherein the predetermined thresholds comprise sale dollar amounts.

15. The method as recited in claim 13, wherein the predetermined thresholds comprise sales volume amounts.

16. A computer readable media having embedded computer executable instructions for creating a customized catalog, the instructions performing steps comprising:
collecting information from a target customer;
using the information collected from the target customer and a cluster analysis algorithm to select from a plurality of customers a reference customer for the target customer;
using previously captured purchasing behaviors specific to the reference customer to select items from a universe of items; and
aggregating the selected items to thereby create the customized catalog for the target customer.

17. The computer readable media as recited in claim 16, wherein each of the sciceted items is included on a pre-existing page of one or more electronic catalogs and the pre-existing pages having the selected items are aggregated to thereby create the customized catalog.

18. The computer readable media as recited in claim 16, wherein the instructions use the information collected from the target customer to filter the selected items prior to the selected items being aggregated to thereby create the customized catalog.

19. The computer readable media as recited in claim 16, wherein the instructions use the information collected from the target customer to add items to the selected items prior to the selected items being aggregated to thereby create the customized catalog.

20. The computer readable media as recited in claim 17, wherein the instructions provide a mark to pre-existing catalog pages that include a selected item which the target customer is known to have previously purchased.

21. The computer readable media as recited in claim 17, wherein the instructions provide the customized catalog with a barcode indicative of a selected item which the target customer is known to have previously purchased.

22. The computer readable media as recited in claim 16, wherein the instructions include with the customized catalog a coupon for a selected item.

23. The computer readable media as recited in claim 16, wherein the instructions store the customized catalog to provide downloading of the customized catalog via the Internet.

24. The computer readable media as recited in claim 23, wherein the instructions provide to the target customer an email which includes a link to a downloadable version of thc customized catalog.

25. The computer readable media as recited in claim 16, wherein the instructions select the reference customer from a plurality of reference customers within a predefined category of reference customers.

26. The computer readable media as recited in claim 25, wherein the predefined category is indicative of a vocation.

27. The computer readable media as recited in claim 25, wherein the instructions collect information from the reference customer for determining a predefined category of reference customers into which the reference customer is to be placed whereby the predetermined category of reference customers is used to define the plurality of customers from which the target customer is selected.

28. The computer readable media as recited in claim 16, comprising using predetermined thresholds to eliminate items from the selected items prior to the selected items being aggregated to thereby create the customized catalog.

29. The computer readable media as recited in claim 28, wherein the predetermined thresholds comprise sale dollar amounts.

30. The computer readable media as recited in claim 28, wherein the predetermined thresholds comprise sales volume amounts.
